(19) United States
(12) Patent Application Publication
(10) Pub. No.: US 2005/0234685 A1
(43) Pub. Date: Oct. 20, 2005

(54) Information processor and program

(75) Inventor: Hidekazu Tanigawa, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: IRD CORP, OSAKA (JP)

(21) Appl. No.: 10/518,089

(22) PCT Filed: Oct. 16, 2003
(86) PCT No.: PCT/JP03/13277

§ 371 Date: Dec. 16, 2004

(30) Foreign Application Priority Data
Oct. 23, 2002 (JP) 2002-308778

(51) Int. Cl. G06F 7/60

(52) U.S. Cl. 703/2

(57) ABSTRACT

The invention provides a program that enables a computer to execute a specification analysis step of reading-in a specification and analyzing it, a patent value calculation step of quantitatively calculating a patent value based on analysis results obtained in the analysis step, and a patent value output step of outputting that patent value. Thereby, a patent value and a specification quality can be assessed using quantitative expressions.

### BACKGROUND OF THE INVENTION

1. Field of the Invention

The present invention relates to programs capable of performing analysis and other processes pertinent to patent specifications, and to data processing devices therefor.

2. Description of Related Art

Conventionally, techniques employed for analysing and performing other processes pertaining to patent specifications are embodied in software that supports patent specification preparation, which examines how claims are cited in other descriptive sections, checks the number of words within an abstract, checks document formatting, and also the numbers assigned to claims, paragraphs, drawings, and formulas, and then generates a summary.

However, the conventional technique mentioned above is incapable of rendering and graphically representing how various claims are interwoven, so those who rely on the existing technique cannot readily obtain an outline of the claims, especially when handling a large number of them, and are therefore prone to making errors in defining the scope of claims. The same limitation is responsible for additional problems such as in the case of divisional applications, where it is difficult to determine whether a particular claim should be split off for use in a relevant application, or deleted, or should remain in the parent application. Another problem concerns intermediate procedures, where it is still difficult to determine which group of claims should be amended or deleted.

Moreover, it is impossible for those using the above-mentioned conventional technique to appreciate, using quantitative expressions, not only a given patent value (i.e., how inventive a relevant claimed invention is) but also the quality of the patent specification at hand. Thus, in the field of patent distribution, where licensing and securitization of patent rights are the focus, in order to settle an invention value and the corresponding price of a particular patented invention, one has to resort to the skills of persons well-versed in the specification in which the patented invention is precisely defined for its protection. In addition, the difficulty of grasping and evaluating the overall quality when drafting a specification results in a substantial number of incomplete applications filed, applications that fail to fulfill the enablement requirement.

Furthermore, the conventional technique fails to provide a checking feature to ensure the consistency of reference numerals. Therefore, consistency has to be checked manually, which compounds the problem by increasing the likelihood of further inconsistencies as more reference numerals are added.

### SUMMARY OF THE INVENTION

Accordingly, in order to overcome the drawbacks inherent in the conventional art, a first aspect of the present invention is to provide a computer program capable of analyzing a patent specification. Specifically, this program enables a computer to execute a claim hierarchy obtainment step of analyzing claims (the “What is claimed is” section) of a patent specification and obtaining the independent-dependent relationships between the claims; and a claim tree display step of displaying a hierarchical tree-like claim structure using a graphic representation based on the independent-dependent claim relationships obtained in the hierarchy obtainment step. Using this program, one can benefit from an overall picture of the structured claims, and can complete the “What is claimed is” section without the risk of losing any fragment or detail pertaining to the subject matter. This program therefore offers a particularly effective and useful solution when handling a large number of claims.

A second aspect of the present invention is to provide a computer program that enables a computer to execute the following steps: a specification analysis step of reading-in a specification and analyzing it; a patent value calculation step of quantitatively calculating a patent value based on the analysis results obtained in the specification analysis step; and a patent value output step of outputting the patent value. With this program, one can appreciate how inventive a relevant patent is (i.e., the patent value) as well as the quality of its specification, using quantitative expressions.

A third aspect of the present invention is to provide a computer program that enables a computer to execute the following steps: a numbered element obtainment step of analyzing a specification and obtaining elements with reference numerals therefrom; a judgment step of judging which elements may be wrongly numbered in a group of more than one element with a reference numeral obtained in the numbered element obtainment step; and an output step of outputting the presence of any wrong-numbered elements and/or such elements per se. This program therefore checks whether or not reference numerals have been correctly added.

It should be noted that the above programs could be realized by hardware. When doing so, the above features are realized as a data processing device capable of analyzing a patent specification (hereinafter simply called specification).

### BRIEF DESCRIPTION OF ACCOMPANYING DRAWINGS

FIG. 1 is a block diagram illustrating a data processing device in accordance with a first embodiment of the present invention.

FIG. 2 is a flowchart depicting operations of the data processing device in accordance with the first embodiment of the present invention.

FIG. 3 shows an example of a specification in accordance with the first embodiment of the present invention.

FIG. 4 is a hierarchical claim relationship management table in accordance with the first embodiment of the present invention.

FIG. 5 shows an example of displaying a claim tree in accordance with the first embodiment of the present invention.

FIG. 6 shows another example of displaying a claim tree in accordance with the first embodiment of the present invention.

FIG. 7 shows yet another example of displaying a claim tree in accordance with the first embodiment of the present invention.

FIG. 8 shows yet another example of displaying a claim tree in accordance with the first embodiment of the present invention.

FIG. 9 shows yet another example of displaying a claim tree in accordance with the first embodiment of the present invention.

FIG. 10 shows yet another example of displaying a claim tree in accordance with the first embodiment of the present invention.

FIG. 11 shows yet another example of displaying a claim tree in accordance with the first embodiment of the present invention.

FIG. 12 shows yet another example of displaying a claim tree in accordance with the first embodiment of the present invention.

FIG. 13 is a block diagram illustrating a data processing device in accordance with a second embodiment of the present invention.

FIG. 14 is a flowchart depicting operations of the data processing device in accordance with the second embodiment of the present invention.

FIG. 15 is a flowchart depicting a specification analysis routine for the data processing device in accordance with the second embodiment of the present invention.

FIG. 16 is a flowchart depicting a patent value calculation routine for the data processing device in accordance with the second embodiment of the present invention.

FIG. 17 shows an example of analysis results in accordance with the second embodiment of the present invention.

FIG. 18 shows an example of a patent value outputted in accordance with the second embodiment of the present invention.

FIG. 19 is a block diagram illustrating a data processing device in accordance with a third embodiment of the present invention.

FIG. 20 is a flowchart depicting operations of a data processing device in accordance with the third embodiment of the present invention.

FIG. 21 is an element management table in accordance with the third embodiment of the present invention.

FIG. 22 shows an example of results from a numerical consistency check in accordance with the third embodiment of the present invention.

FIG. 23 shows an example of a patent value outputted in accordance with the second embodiment of the present invention.

### DETAILED DESCRIPTION OF THE PREFERRED EMBODIMENTS

Preferred embodiments of a data processing device of the present invention will be discussed hereinafter, making reference to the accompanying drawings. Here note that the same reference numerals are used throughout the drawings and the description in order to refer to the same or similar constituent elements in terms of their behavior or function, and descriptions thereof will not be repeated.

Embodiment 1.

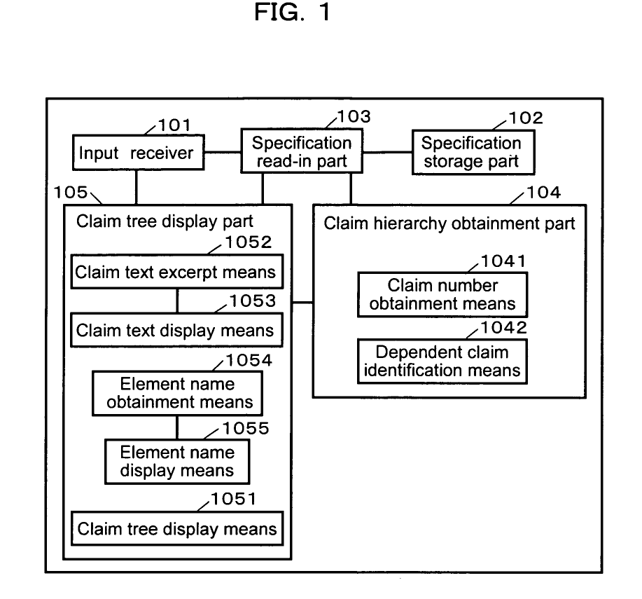

Referring to FIG. 1, a block diagram illustrating a data processing device in accordance with a first embodiment is shown. This device includes an input receiver 101, a specification storage part 102, a specification read-in part 103, a claim hierarchy obtainment part 104, and a claim tree display part 105.

The claim hierarchy obtainment part 104 includes a claim number obtainment means 1041, and a dependent claim identification part 1042. The claim tree display part 105 includes a claim tree display means 1051, a claim text excerpt means 1052, a claim text display means 1053, an element name obtainment means 1054, and an element name display means 1055.

The input receiver 101 receives any one of the following commands: a claim tree display command for displaying a claim tree, a claim text display command for displaying the text of a claim in accordance with a particular node on a claim tree, an element name display command for displaying the name of an element set forth in a claim in accordance with a node on a claim tree, and a process termination command for terminating an ongoing process. Here note that the “claim tree” in this context represents relationships between independent claims and their dependent claims in a hierarchical fashion. The input receiver 101 can typically be realized by driver software for an input means such as a mouse or a keyboard.

The specification storage part 102 stores at least one specification, and can be realized by either a non-volatile memory device or a volatile memory device.

When the input receiver 101 receives a claim tree display command, the specification read-in part 103 reads-in a specification, as specified by the input receiver 101, from the storage part 102. However, if the storage part 102 contains only one specification, that specification will be taken out. Typically, the specification read-in part 103 can be formed by an MPU, a memory device, and the like, and processes assigned thereto are realized by software that is stored in a recording medium such as a hard disk. However, hardware implementation (using a dedicated circuit) is also feasible.

The claim number obtainment means 1041 obtains claim numbers assigned to the claims (where a relevant specification is written in Japanese, it obtains claim numbers designated by the “claim tag” under “What is claimed is.”) Typically, the obtainment means 1041 can be formed by an MPU, a memory device, and the like, and processes assigned thereto are realized by software that is stored in a recording medium such as a hard disk. However, hardware implementation (using a dedicated circuit) is also feasible.

The dependent claim identification means 1042 identifies dependent claims, by their claim numbers, among the claims that correspond to the numbers obtained by the claim number obtainment means 1041. Note that concerning this identification, the kind of algorithm that operates will be discussed in detail below. Then, hierarchical claim relationships can be modeled by using the claim numbers and the dependent-claim numbers obtained by the claim number obtainment means 1041 and the dependent claim identification means 1042, respectively. Typically, the dependent claim identification means 1042 can be formed by an MPU, a memory device, and the like, and processes assigned thereto are realized by software that is stored in a recording medium such as a hard disk. However, hardware implementation (using a dedicated circuit) is also feasible.

The claim tree display means 1051 displays a claim tree, using the claim numbers and dependent-claim numbers obtained by the claim hierarchy obtainment part 104. Typically, the display means 1051 can be realized using an MPU, a memory device, and the like, and processes assigned thereto are realized by software that is stored in a recording medium such as a hard disk. However, hardware implementation (using a dedicated circuit) is also feasible.

The claim text excerpt means 1052 extracts from the relevant specification the text of a claim in accordance with the particular node on the claim tree (one node represents one claim.) Typically, the excerpt means 1052 can be formed by an MPU, a memory device, and the like, and processes assigned thereto are realized by software that is stored in a recording medium such as a hard disk. However, hardware implementation (using a dedicated circuit) is also feasible.

The claim text display means 1053 displays the text portions extracted by the claim text excerpt means 1052 in such a manner that the correspondence of the text portions with the nodes (representing respective claims) is visually clear and unambiguous. Typically, the display means 1053 can be formed by an MPU, a memory device, and the like, and processes assigned thereto are realized by software that is stored in a recording medium such as a hard disk. However, hardware implementation (using a dedicated circuit) is also feasible.

The element name obtainment means 1054 obtains the names of elements comprising a claim in accordance with a node on the claim tree. There is a variety of algorithms for this process, one of which is that the element name obtainment means 1054 obtains {a letter string + “part,” “member,” “unit” and the like referring to the substance of the subject matter} or {a letter string + “means.”} Since this process is enabled by known language processing techniques such as parsing and lexical analysis, a further description is omitted. Typically, the element name obtainment means 1054 can be formed by an MPU, a memory device, and the like, and processes assigned thereto are realized by software that is stored in a recording medium such as a hard disk. However, hardware implementation (using a dedicated circuit) is also feasible.

The element name display means 1055 displays the names of the elements obtained by the element name obtainment means 1054 in such a manner that the correspondence of the names with the nodes representing the claims in which those elements are set forth is visually clear and unambiguous. Typically, the display means 1055 can be formed by an MPU, a memory device, and the like, and processes assigned thereto are realized by software that is stored in a recording medium such as a hard disk. However, hardware implementation (using a dedicated circuit) is also feasible.

It should be noted that the claim tree display means 1051, the claim text display means 1053, and the element name display means 1055 may be or may not be provided with a display device.

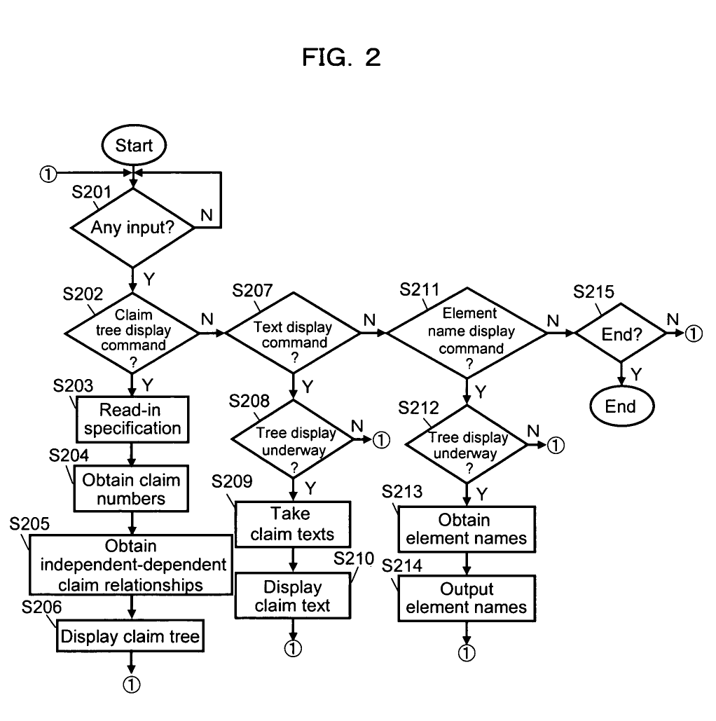

Hereinafter, operations of the data processing device in the first embodiment will be discussed by referring to the flowchart shown in FIG. 2.

In step S201, the input receiver 101 checks whether or not any input has been received. If reception is confirmed, it proceeds to step S202; otherwise, it remains at step S201.

In step S202, the input receiver 101 checks whether or not the current input is a claim tree display command. If the input is identified as such, it proceeds to step S203; otherwise, it skips to step S207.

In step S203, the specification read-in part 103 reads-in a specification from the specification storage part 102, as specified by the input receiver 101.

In step 204, the claim number obtainment means 1041 obtains those numbers assigned to each claim (where a relevant specification is written in Japanese, it obtains those numbers designated by the claim tag under “What is claimed is”) from the specification read in step S203.

In step S205, the dependent claim identification means 1042 identifies dependent claims, by their claim numbers, among the claims that correspond to the numbers obtained in step S204.

In step S206, the claim tree display means 1051 displays a claim tree based on the claim numbers and the dependent claim numbers obtained in steps S204 and S205, respectively. In other words, the numbers obtained in the preceding two steps are used to model the hierarchical relationships among the claims, which can then be shown on a display.

In step S207, the input receiver 101 checks whether or not the current input is a text display command. If the input is identified as such, it proceeds to step S208; otherwise, it skips to step S211.

In step S208, the input receiver 101 checks whether or not the claim tree is currently being displayed. If the display is in progress, it proceeds to step S209; otherwise, it returns to step S201.

In step S209, the claim text excerpt means 1052 extracts from the specification read in S203 the text of a claim in accordance with a node on the claim tree (one node represents one claim.)

In step S210, the claim text display means 1053 displays the texts extracted in step S209 in such a manner that the correspondence of the texts with the nodes is visually clear and unambiguous. Apart from this, various visual display styles are feasible for this process, one of which has a block of text and its corresponding node linked by a line. Another feasible display style is one in which a block of text is displayed in the close vicinity of its corresponding node.

In step S211, the input receiver 101 checks whether or not the current input is an element display command. If the input is identified as such, it proceeds to step S212; otherwise, it skips to step S215.

In step S212, the input receiver 101 checks whether or not the claim tree is currently being displayed. If the display is in progress, it proceeds to step S213; otherwise, it returns to step S201.

In step S213, using the specification read-in during step S203, the element name obtainment means 1054 obtains the names of the elements set forth in the claims that correspond to the nodes on the claim tree.

In step S214, the element name display means 1055 displays the names of the elements obtained in step S213 in such a manner that the correspondence of the names with the nodes representing the respective claims in which those elements are set forth is visually clear and unambiguous. Various other display styles are feasible for this process, one of which has an element name and the node of its associated claim linked by a line. Another feasible mode is one in which element names are displayed in the close vicinity of their associated claims' nodes.

In step S215, the input receiver 101 determines whether or not the current input is a termination command. If the input is identified as such, the ongoing process will end; otherwise, it returns to step S201.

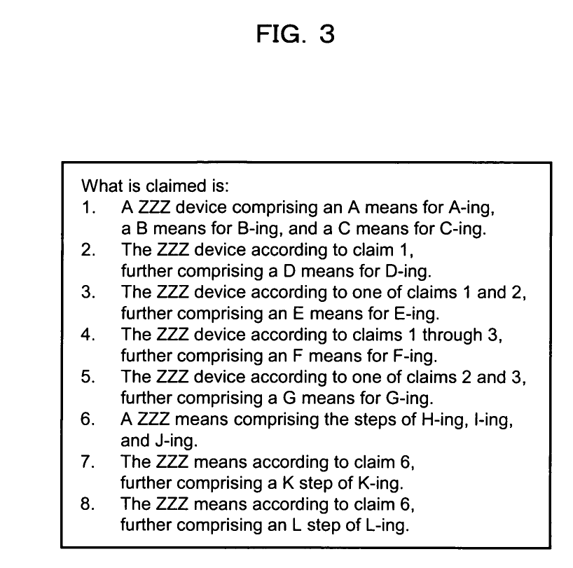

The operations of the data processing device in the first embodiment will be discussed in detail below. Suppose that the processing device has a specification (e.g., the “What is claimed is” section as shown in FIG. 3) stored and that a user has entered a display command calling for a claim tree of this specification to be displayed.

First, the specification read-in part reads-in the specification (FIG. 3) from the specification storage part. Then, from that specification, the claim number obtainment means obtains the claim numbers “1” through “8” in this example. Specifically, when the specification in question is written in Japanese, claim numbers are extracted from each letter string within the square brackets called the tag.

Then, according to these claim numbers, the dependent claim identification means identifies dependent claims, by their claim numbers, among the claims that correspond to those numbers previously obtained. For example, from the text of each claim, letter strings indicating a dependent claim are obtained. These include, for example, “according to claim ?*,” “according to one of the claims ?* and ?*,” “according to claims ?* to ?*,” and “according to claims ?* through ?*,” where “?” represents any positive integer, and “*” represents zero or more repetitions of the integer preceding.

Next, from those letter strings, the dependent claim identification part picks out numeral strings “?*” and letter strings between them (i.e., “through,” “to,” or “and”). If a combination of numerals and a letter string such as “1 through 3” is picked out, then it is replaced by “1, 2, 3”. Through this process, the claim containing that string turns out to be a dependent claim, a claim dependent on the independent claims 1, 2, and 3.

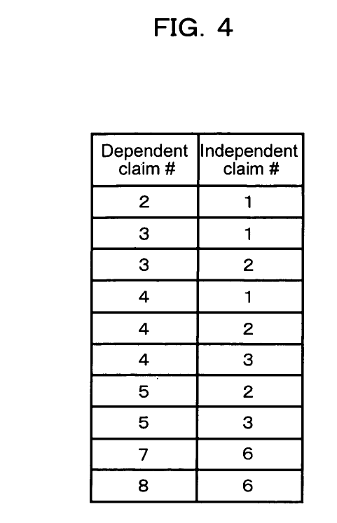

In this manner the claims in FIG. 3 are analyzed so as to obtain hierarchical relationships therebetween as shown in FIG. 4, which is a hierarchical claim relationship management table showing the independent-dependent correspondence between the claims.

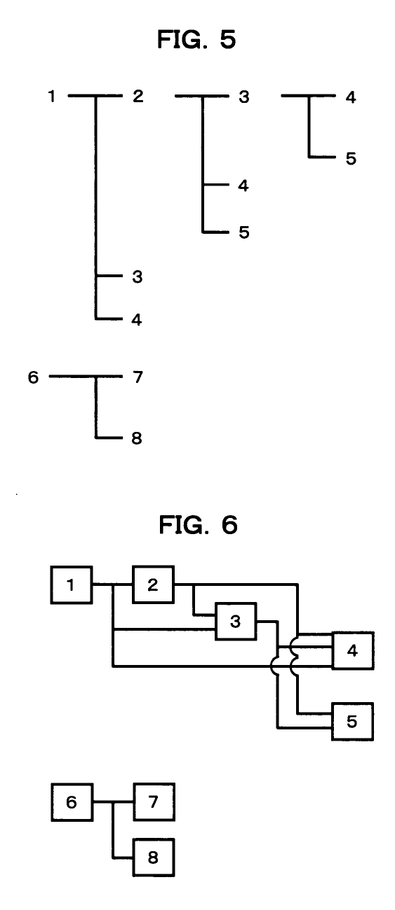

Based on this table, the claim tree display means displays a claim tree as shown in FIG. 5. This figure shows one of the feasible display styles, in which, on the basis of independent claims, the dependent claims are linked to them using a solid line, and claim numbers appear more than once.

Also, based on the same hierarchical claim relationship management table, another display style as shown in FIG. 6 is feasible for the tree display means, in which, on the basis of independent claims, the dependent claims are linked to them using a solid line, but claim numbers appear only once.

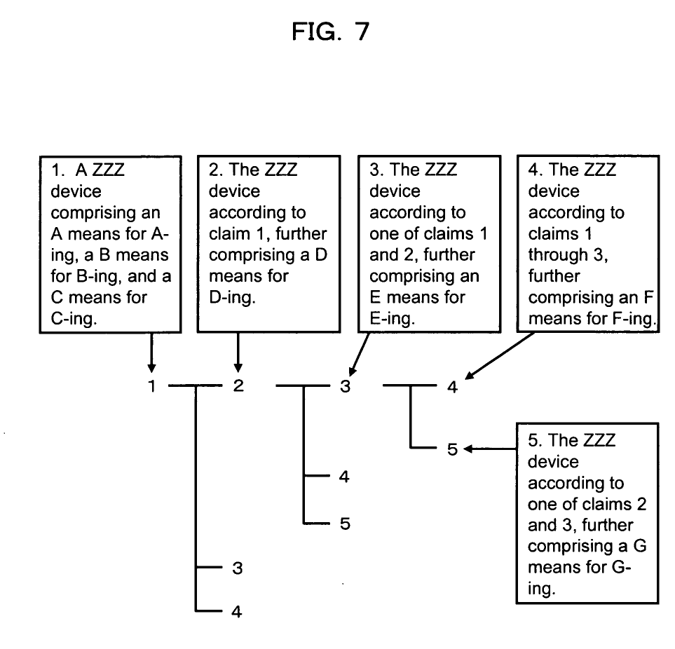

Let us now suppose that a user wishes to display the text of claim 1, and where the claim tree in FIG. 5 is displayed, that the user has entered a text display command while specifying “1,” using a mouse. Here note that this entry may alternatively be processed in response to the user pulling down a selection menu that shows the display options available and then selecting a text display function therefrom, or by the user left-clicking with the mouse to reach that selection menu. Then, in response to the entry, the text of claim 1 will be displayed in such a manner that the correspondence with the numeral “1” on the claim tree can be easily seen. Again let us suppose that a user has specified “2,” “3,” “4,” and “5” on the claim tree in the same manner as described above, so that each corresponding claim text can be read. Then the resulting display will be as shown in FIG. 7, in which the requested claim texts are shown on the claim tree.

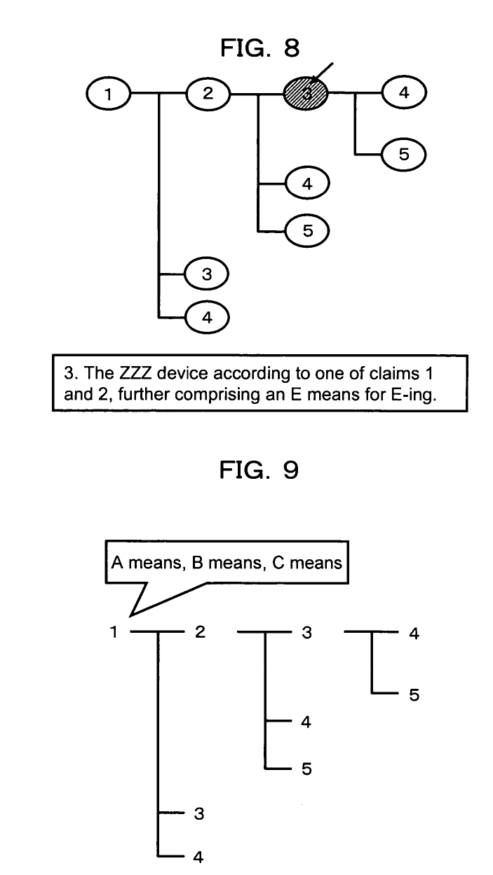

It should be noted that the method of displaying a requested claim text on a claim tree is not limited to those described above; other styles such as those shown in FIG. 8 are also feasible. In short, in order to display a claim tree and one or more claim texts, any style that maintains visual clarity is acceptable. In FIG. 8, the claim that a user desires to read (“3” in this case) appears on the claim tree in a distinctive manner, and its corresponding text is shown at the bottom of the display.

Regarding an element name display command, let us suppose that a user has entered one while specifying “1” using a mouse, where the claim tree in FIG. 5 is displayed. Here note that this entry may alternatively be processed by the user pulling down a selection menu showing the display options available, and then selecting an element display function therefrom, or by the user left-clicking with the mouse to reach that selection menu. Then, in response to the entry, the elements set forth in claim 1 will be displayed as shown in FIG. 9.

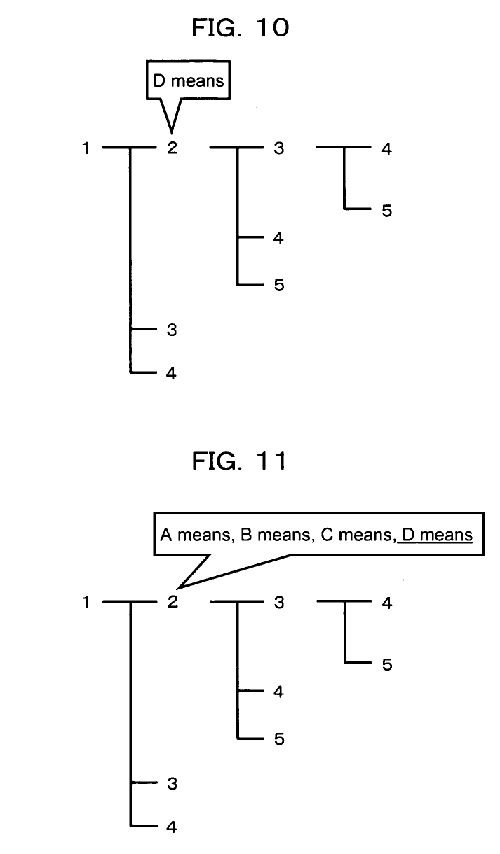

If that user had entered the element name display command while specifying “2” with the mouse, the resulting display would be as shown in FIG. 10, revealing an element set forth in claim 2. Furthermore, other variations are feasible as shown in FIG. 11, in which elements of claim 2's parent are also obtained and shown at the same time. In this case, when the user specifies “2” using the mouse, and enters an element name display command, all the elements set forth in claim 2 as well as its parent claim 1 appear on a screen, namely, A means, B means, C means, and D, means. Here note that as shown in FIG. 11, the requested claim's element “D means” may be distinguishable within the display from those of the parent. According to FIG. 11, only “D means” is underlined.

As clarified above, using the first embodiment of the present invention, claims in a specification are analyzed so that hierarchical claim relationships therebetween can be displayed as a graphic representation of a tree. In this way, the user can easily examine, at the time an application is filed, the degree to which the subject matter of his or her invention is properly formulated into claims. Furthermore, the display of a claim tree in accordance with the first embodiment allows the user to comprehend and appreciate the structure of the specification at a glance. Hence, the response to any rejection made can be accelerated. In terms of licensing, the claim tree display allows the user to decide which claims to place under exclusive license or nonexclusive license. In addition, using the first embodiment, claim texts and elements therein can be shown in relation to nodes (representing a corresponding claim) on a claim tree. Because of this, the required procedures will be facilitated at any of the above-mentioned stages.

It should be noted that in the first embodiment of the present invention, the texts of claims and the names of the elements therein are displayed in accordance with the corresponding nodes on a claim tree, as specified by a user, but another feasible display style is one in which the display of claim texts and element names is automatically concurrent with the display of a claim tree. In short, the timing for displaying claim texts and element names is irrelevant. In addition, the display of claim texts and/or element names requested by the user when he or she specifies a node on a claim tree may automatically disappear after a certain time elapses.

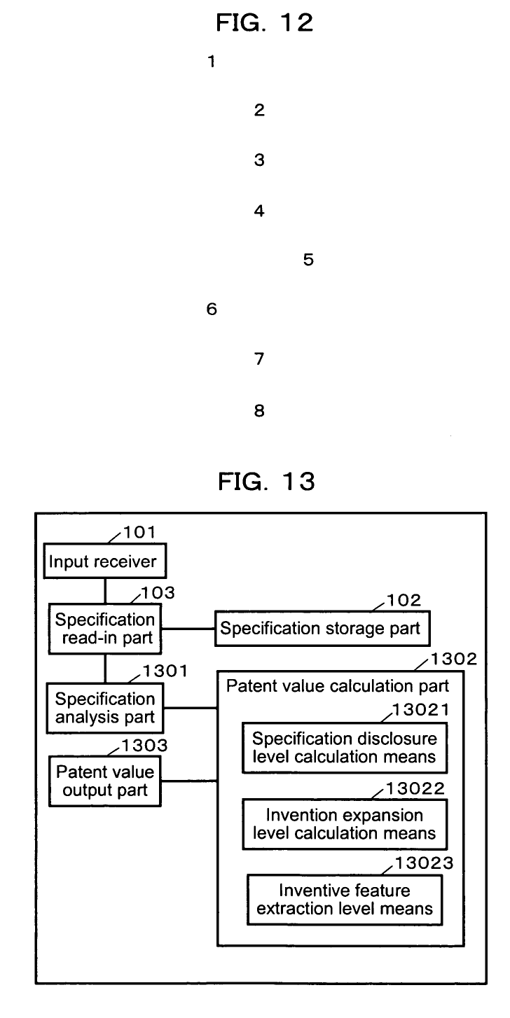

In accordance with the first embodiment, a claim tree is displayed so that solid lines link nodes. However, as shown in FIG. 12, the hierarchy of claim relationships may be represented by a hierarchy of indents. In short, any display style that offers visual clarity is feasible for graphically representing the hierarchical structure of the claims.

The operations set forth in the first embodiment of the present invention may be realized using a computer-readable program. Such a program may be distributed in a recording medium such as a CD-ROM or through a network, or may be broadcast. This also applies to any embodiments other than this. It should, however, be noted that a program for executing the operations of the data processing device as discussed in the first embodiment is provided for executing a claim hierarchy obtainment step of analyzing claims of a specification, and obtaining hierarchical relationships therebetween, and a claim tree display step of displaying those hierarchical relationships as a claim tree using a graphic representation. Moreover, a program for executing the operations of the data processing device as set forth in the first embodiment is provided for enabling a computer to execute a claim hierarchy obtainment step of analyzing claims of a specification, and obtaining hierarchical relationships therebetween, and a claim tree display step of displaying those hierarchical relationships as a claim tree using a graphic representation, and further displaying part or whole of a claim text in accordance with a node on the claim tree. In this program, part of a claim text may be a name of an element set forth in a claim in question.

Embodiment 2.

Referring to FIG. 13, a block diagram illustrating a data processing device in accordance with a second embodiment of the present invention is shown. This device includes an input receiver 101, a specification storage part 102, a specification read-in part 103, a specification analysis part 1301, a patent value calculation part 1302, and a patent value output part 1303. The patent value calculation part 1302 includes a specification disclosure level calculation means 13021, an invention expansion level calculation means 13022, and an inventive feature extraction level calculation means 13023.

The input receiver 101 receives a patent value output command that requests that a patent value be output.

The specification analysis part 1301 analyzes a specification stored in the specification storage part 102. The analysis in this context includes parsing, lexical analysis, and the like, and would usually mean a process of counting the number of words, for example, for predetermined items of a specification, and a process of counting the number of elements set forth in each claim (a more detailed discussion will be given below.) Typically, the specification analysis part 1301 can be formed by an MPU, a memory device, and the like, and processes assigned thereto are realized by software that is stored in a recording medium such as a hard disk. However, hardware implementation (using a dedicated circuit) is also feasible.

The patent value calculation part 1302 quantitatively calculates a patent value based on the analysis results obtained by the specification analysis part 1301. The patent value is obtained in light of multiple characteristics intrinsic to a specification, such as specification disclosure level, invention expansion level, and inventive feature extraction level, which will be discussed in detail later. The calculation part 1302 may calculate one value, for example, using those multiple characteristics as parameters (i.e., by weighing multiple characteristics), or may calculate a value for each of the characteristics. Typically, the patent value calculation part 1302 can be formed by an MPU, a memory device, and the like, and processes assigned thereto are realized by software that is stored in a recording medium such as a hard disk. However, hardware implementation (using a dedicated circuit) is also feasible.

The specification disclosure level calculation means 13021 calculates a specification disclosure level that indicates how properly a claimed invention set forth under “What is claimed is” is rephrased in other descriptive parts of the specification, so as to ensure that the full scope of the claimed invention is enabled. The calculation means 13021 calculates a specification disclosure level, for example, following the formula {number of words for preferred embodiments/number of words for claims.} The formula used is not limited to this particular formula, however.

The invention expansion level calculation means 13022 calculates an invention expansion level that indicates how broadly a relevant invention is expanded. The invention expansion level (f) is obtained, for example, following the formula {f=“number of claims”* 0.5+“depth of claim nesting level”*0.3+“number of claim categories”*0.2}. Here “depth of claim nesting level” indicates the deepest level of a claim hierarchy represented by a claim tree. In the example of the claim tree in FIG. 5, the number is four, since there are four levels. The “number of claim categories” indicates how many of the four categories (“device,” “means,” “medium,” and “program”) are covered. Note that the formula used is not limited to this particular formula, however.

The inventive feature extraction level calculation means 13023 calculates an inventive feature extraction level that indicates how properly the subject matter is extracted. The inventive feature extraction level (g) is obtained, for example, using as a parameter the smallest number of elements set forth in an independent claim (x), by applying {100/x}.

The patent value output part 1303 outputs a patent value obtained by the patent value calculation part 1302. For this process, any other modes are feasible. For example, each characteristic of the patent value may be outputted in the form of a numerical value. Another feasible mode uses a graphical method, in which characteristics may be plotted on each axis of a radar chart, for example. It is needless to say that the graphic representation is not limited to the style of a radar chart. The output in this context would usually mean a display on a screen, printing to a printer, sending of data to other devices, or the like. The patent value output part 1303 may be or may not be provided with an output device such as a display. Typically the output part 1303 can be formed by an MPU, a memory device, and the like, and processes assigned thereto are realized by software that is stored in a recording medium such as a hard disk. However, hardware implementation (using a dedicated circuit) is also feasible.

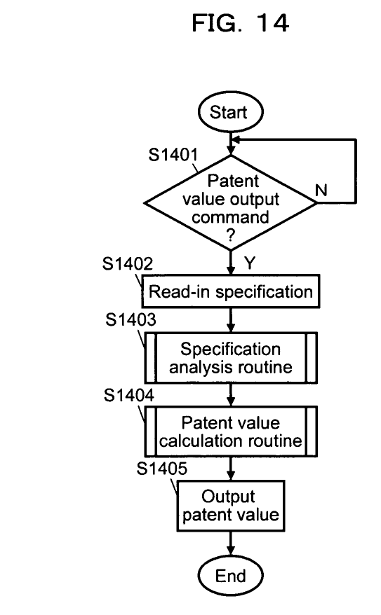

Next, the operations of the data processing device in the second embodiment will be discussed by referring to the flowchart shown in FIG. 14.

In step S1401, the input receiver 101 checks whether or not the current input is a patent value output command. If the input is identified as such, it proceeds to S1402: otherwise, it remains at S1401. Typically, the input includes information that specifies a specification to be outputted.

In step 1402, the specification read-in part 103 reads-in a specification from the specification storage part 102, normally, as specified by the information mentioned above.

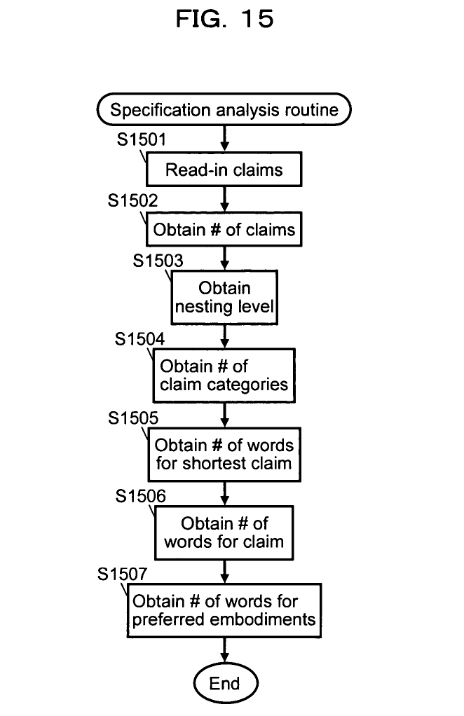

In step S1403, the specification analysis part 1301 analyzes the specification read-in during step S1402. This is called a “specification analysis routine,” which will be discussed in detail later with reference to FIG. 15.

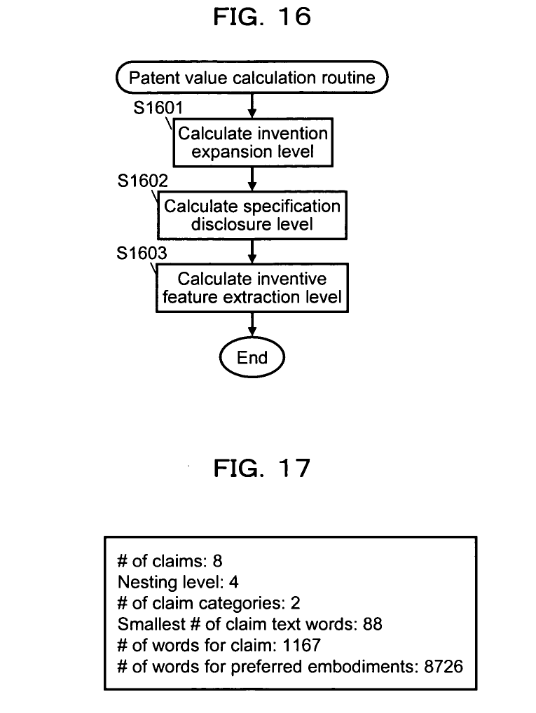

In step S1404, the patent value calculation part 1302 quantitatively calculates a patent value based on the analysis results obtained in step S1403. This is called a “patent value calculation routine,” which will be discussed in detail later with reference to FIG. 16.

In step S1405, the patent value output part 1303 outputs the patent value obtained in step S1404.

The specification analysis routine goes through the following steps (see FIG. 15).

In step S1501, within the specification, the “What is claimed is” section is read-in.

In step S1502, the number of claims is obtained.

In step S1503, the nesting level of the claim hierarchy is obtained.

In step S1504, the number of claim categories is obtained.

In step S1505, among all independent claims, the number of words of the shortest claim is obtained.

In step S1506, the total number of words for all claims is obtained.

In step S1507, the total number of words for all preferred embodiments is obtained.

The following describes how the number of claims, number of words, number of claim categories, and the nesting level are obtained. First, the number of claims is equal to the largest number assigned to the last claim. Next, the nesting level can be obtained when a claim hierarchy is properly modeled (see “Embodiment 1”). The number of claim categories can be obtained by obtaining tail terms such as “device,” “means,” and “program” within claims, and counting the number of such terms present. How to obtain the number of words is omitted since it is obvious.

The patent value calculation routine performs the following steps (see FIG. 16).

In step S1601, the invention expansion level (f) is obtained through the use of a formula such as {f=“number of claims”*0.5+“depth of claim nesting level”*0.3+“number of claim categories”*0.2}.

In step S1602, the specification disclosure level is obtained through the use of a formula such as {number of words for preferred embodiments/number of words for claims}.

In step S1603, the inventive feature extraction level (g) is obtained using as a parameter the number of words within the shortest claim (y). For example, this level may be expressed using {100/y}.

It should be noted that through the processes described in FIG. 16, the invention expansion level, specification disclosure level, and inventive feature extraction level may be used as parameters, so as to obtain a single unified patent value. Moreover, such a value may be outputted on a scale of 100.

The operations of the data processing device in the second embodiment will be discussed below in detail. Let us now suppose that following the lexical analysis and parsing of a specification specified by a user, results are obtained as shown in FIG. 17. Then, when the formula mentioned above is applied, it yields {f=8* 0.5+4* 0.3+0.2=5.6.}

Next, in order to obtain the inventive feature level (g), the formula {100/number of words within the shortest claim} is applied, which yields {g =100/88=approximately 1.14.}

After that, in order to obtain the specification disclosure level (h), the formula {number of words for preferred embodiments/number of words for claims} is applied, which yields {h=8726/1167= approximately 7.48.}

Finally, the patent value calculation part obtains the level of overall “patent value” points by weighing the invention development level (f=5.6), the inventive feature extraction level (g=1.14), and the specification disclosure level (h=7.48). To further clarify this process, suppose that the patent value calculation gives a value of 70 points.

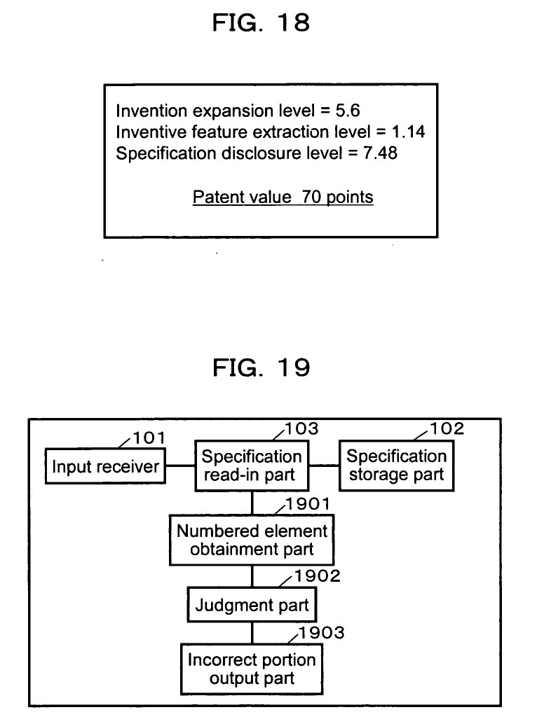

Following the above calculation, the patent value output part proceeds with a display as shown in FIG. 18. On the display, for each level, a reference score may appear simultaneously, so as to provide acceptance/rejection criteria. Such criteria should be stored in advance in the data processing device; however, the score will vary depending on the technical field.

As clarified above, in accordance with the second embodiment of the present invention, the specification analysis allows a patent value to be calculated. Then, using such an automated patent value calculation, an applicant can properly assess the manpower required for patent maintenance. Also, this calculation is adaptable to patent securitization, and mechanical screening for licensing. The patent value can be used as a reference for settling a royalty fee. In addition, on the basis of the specification characteristics expressed in the score, a patent value can be estimated with higher accuracy, and at the time of drafting a specification, error-correction, among other factors, would be facilitated.

It should be noted that in the second embodiment, the “patent value” is equivalent to a “patent quality” in that “quality” is one of the elements composing a “value.” Thus, it can be said that calculation of a patent value is calculation of a patent quality.

The following will describe other variations of the second embodiment.

Characteristics intrinsic to a specification are not limited to those mentioned above, any other characteristics are acceptable.

Assessment of patent value or quality need not be based solely on results from the specification analysis; it may also be calculated by adding other information such as the amount of sales of an applicant, and amount of capital.

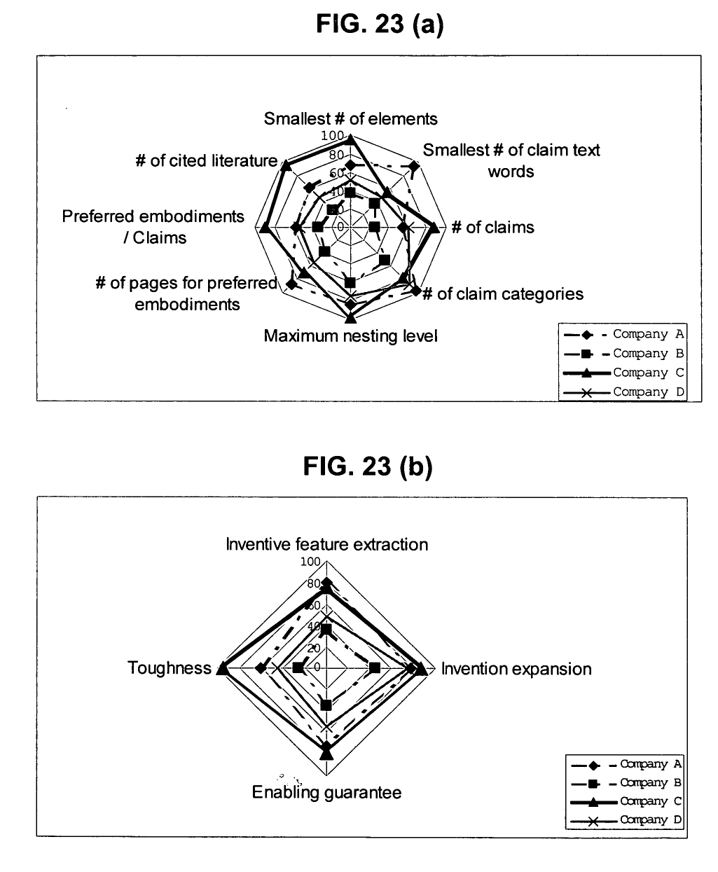

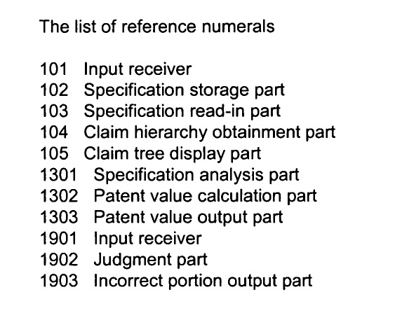

A resulting patent value or quality may be outputted using a graphic representation such as a radar chart in which data is plotted on axes for each characteristic (FIG. 23). Such a graph is preferable as it facilitates the appreciation of a patent value.

A patent value may be calculated as a mean value of multiple specifications. As shown in FIG. 23, it is also feasible for the specification analysis to be performed on multiple applicant entities, and comparison to be made thereof in terms of a filed (registered) patent value. This process will allow comparison of patentability among multiple entities.

In the example shown in FIG. 23(a), raw data is plotted by item before feeding into the calculation of characteristics. Each axis is scaled from zero to 100. Those values plotted along the axis of the “smallest number (#) of elements” are obtained by identifying a claim having the fewest elements for each specification, and adjusting the values thereof, so that a specification whose claim has the fewest elements is assigned the maximum value on a scale of 100. This is based on the view that the smaller the number of elements is, the broader the scope a patent right has. Likewise, the “smallest number (#) of claim text words” indicates values obtained by identifying a claim having the smallest word count for each specification, and adjusting the values thereof, so that a specification whose claim has the smallest word count is assigned the maximum value on the scale. This is based on the view that the smaller the number of claim text words is, the broader the scope a patent right has. The “number (#) of claims” indicates values obtained by counting the number of claims within a specification, and adjusting the values thereof, so that a specification having the most claims is assigned the maximum value on the scale. This is based on the view that the more claims that are included, the better developed an inventive idea is, and hence the higher its patent value. Along the “number (#) of claim categories” axis, the values noted are obtained by counting the number of categories to which each claim belongs for each specification, and adjusting the values thereof, so that a specification having the most categories is assigned the maximum value on the scale. The “maximum nesting level” indicates values obtained by determining the depth of a hierarchy structured by independent-dependent relationships between claims, and adjusting the values thereof, so that a specification having the deepest hierarchy is assigned the maximum value on the scale. This is based on the view that the deeper a claim hierarchy is, the more deeply speculated the inventive idea is (i.e., the inventive idea is fully devised from multiple aspects), and hence the higher its patent value. The “number (#) of pages for preferred embodiments” indicates values obtained by counting the number of pages used for reciting preferred or exemplary embodiments of a claimed invention, and adjusting the values thereof, so that a specification having the largest number of such pages is assigned the maximum value on the scale. This is based on the view that the more pages that are used for reciting preferred embodiments, the more disclosed an invention is. Hence the application is less likely to become null due to its inconformity to the enablement requirement, which would usually mean that its patent value is higher. The “preferred embodiments/claims” indicates values obtained by calculating a ratio of an amount of description for preferred embodiments to an amount of description for claims (for example, in terms of word count), and adjusting the values thereof, so that a specification having the largest ratio is assigned the maximum value on the scale. If the amount of description for preferred embodiments exceeds the amount of description for claims, that invention is generally considered to be fully disclosed, and hence is less likely to become null due to its inconformity to the enablement requirement, which would usually mean that its patent value is higher. The “number (#) of cited literature” indicates values obtained by counting the number of references cited under “Background of the Invention,” and adjusting the values thereof, so that a specification having the largest number of cited references is assigned the maximum value on the scale. This is based on the view that the more references that are cited, the more rigorous the patent search performed for that specification. Hence that application is less likely to receive a rejection or nullification, and its patent value is therefore higher.

In another example, shown in FIG. 23(b), resulting data is plotted by characteristic. This chart is obtained by quantifying each characteristic using the method mentioned above. The “toughness” is assigned a higher score as a patent search is fully performned, and the “number of cited literature” increases. For this score, a value from the “number of cited literature” in FIG. 23(a) may apply. The “inventive feature extraction level” may be obtained using the “smallest number of elements” and “smallest number of claim text words” values in FIG. 23(a) as parameters. Alternatively, it may be obtained using the “number of claims,” “number of claim categories,” and “maximum nesting level” values as parameters. Moreover, the “enabling guarantee” may be obtained using the “number of pages for preferred embodiments” and “preferred embodiments/claims” values in FIG. 23(a) as parameters.

The operations set forth in the second embodiment of the present invention may be realized using a computer-readable program, which is distributed in a recording medium such as a CD-ROM or through a network, or may be broadcast. It should be noted that a program for executing the operations of the data processing device as set forth in the second embodiment is provided for enabling a computer to execute: a specification analysis step of reading-in a specification and analyzing it; a patent value calculation step of quantitatively calculating a patent value based on the analysis results obtained in the specification analysis step; and a patent value output step of outputting the patent value. Moreover, the patent value calculation step may also calculate a value for each of multiple characteristics intrinsic to a specification, and the patent value output step may also output that value for each of the multiple characteristics.

Embodiment 3.

Referring to FIG. 19, a block diagram illustrating a data processing device in accordance with a third embodiment of the present invention is shown. This device includes an input receiver 101, a specification storage part 102, a specification read-in part 103, a numbered element obtainment part 1901, a judgment part 1902, and an incorrect portion output part 1903.

The input receiver 101 receives a numerical consistency check command that requests that the consistency of the reference numerals assigned to elements be checked.

The numbered element obtainment part 1901 analyzes a specification and obtains all elements with reference numerals therefrom. It is publicly known that this process can be carried out by parsing the specification and performing a lexical analysis. More specifically, the obtainment part 1901 obtains a letter string+{“part,” “member,” “unit” and the like, and “means”}+a numerical string. Typically, the obtainment part 1901 can be formed by an MPU, a memory device, and the like, and processes assigned thereto are realized by software that is stored in a recording medium such as a hard disk. However, hardware implementation (using a dedicated circuit) is also feasible.

From more than one element obtained by the numbered element obtainment part 1901, the judgment part 1902 judges which elements are wrongly numbered. For this, other modifications are feasible. For example, if one numeral is assigned to multiple different elements, the judgment part 1902 judges that such elements are wrong-numbered. If multiple different numerals are assigned to one element within a certain range of a specification (e.g., a specific embodiment), the judgment part 1902 judges that such an element is wrong-numbered. Typically, the judgment part 1902 can be formed by an MPU, a memory device, and the like, and processes assigned thereto are realized by software that is stored in a recording medium such as a hard disk. However, hardware implementation (using a dedicated circuit) is also feasible.

Following the above judgment, the incorrect portion output part 1903 outputs data that indicates the presence of any wrong-numbered elements and/or such elements per se. The output would usually mean a display on a screen, printing to a printer, sending of data to other devices, or the like. The output part 1903 may be or may not be provided with an output medium such as a display. Typically, the output part 1903 can be formed by an MPU, a memory device, and the like, and processes assigned thereto are realized by software that is stored in a recording medium such as a hard disk. However, hardware implementation (using a dedicated circuit) is also feasible.

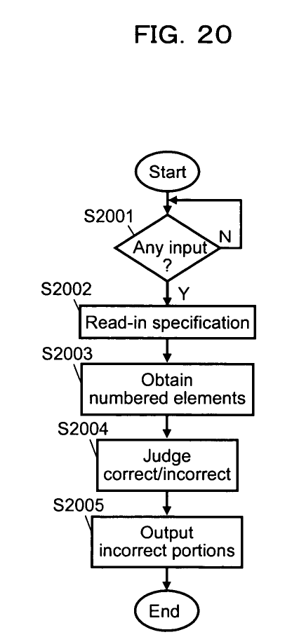

Hereinafter, operations of the data processing device in the third embodiment will be discussed by referring to the flowchart in FIG. 20.

In step S2001, the input receiver 101 checks whether or not the current input is a reference numeral check command. If the input is identified as such, it proceeds to S2002: otherwise, it remains at S2001.

In step S2002, the specification read-in part 103 reads-in a specification from the specification storage part 102, based on the information that specifies which specification to be read-in. This information is generally contained in the input received in step S2001.

In step S2003, the numbered element obtainment part 1901 analyzes the specification read-in during step S2002, and obtains elements with reference numerals therefrom.

In step S2004, from more than one element obtained in S2003, the judgment part 1902 judges which element or elements have wrong numbers.

In step S2005, following the judgment in S2004, the incorrect portion output part 1903 outputs the presence of any wrong-numbered elements or such elements per se.

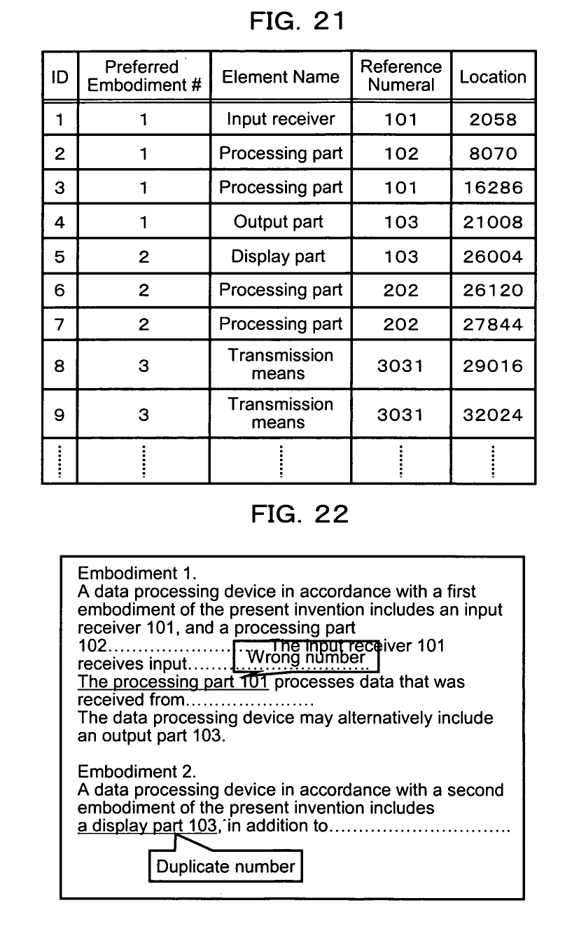

The operations of the data processing device in the third embodiment will be discussed below in detail. Let us now suppose that the data processing device is attempting to read-in a specification, and to obtain an element management table as shown in FIG. 21. The element management table manages at least one record containing data under the headings “ID,” “Preferred Embodiment #,” “Element Name,” “Reference Numeral,” and “Location.” “ID” is information used to identify each record, and serves for handling multiple tables. “Preferred Embodiment #+” indicates the number of an embodiment in which a relevant element is set forth. “Element Name” indicates the name of an element. “Reference Numeral” is a number assigned to each element. “Location” indicates where a numbered element appears within a specification to be filed in units of bytes counting up from the beginning of the specification.

When analyzing a specification, the numbered element obtainment part picks out a letter string+{“means,” or “part,” “unit,” “member,” or the like}+a numeral string. More specifically, “input receiver 101,” “transmission means 3031,” or the like is obtained so as to produce a table such as that shown in FIG. 21.

Subsequent to this, the judgment part judges whether or not a given reference numeral is correctly assigned to the correct element in each record of the table (FIG. 21). More specifically, if multiple different elements are assigned the same numeral, the judgment part judges that such elements are wrongly numbered. If multiple different numerals are assigned to one element, the judgment part judges that such an element is wrong-numbered.

Using the above judgment algorithm, the judgment part comes to the conclusion that either record ID 2 or 3, and either record ID 4 or 5 in FIG. 21 contain wrong-numbered elements.

Alternatively, the judgment part may judge, if multiple different elements are assigned the same numeral, that all elements except for the ‘first’ appearing element are wrong-numbered. Also, it is feasible that where multiple different numerals are assigned to one element in the range of a “specific embodiment,” the judgment part judges that all numerals except for the ‘first’ assigned numeral are wrong-numbered. In this case, those records having IDs 3 and 5 are incorrect.

Following the judgment by the judgment part, the incorrect portion output part outputs the presence of any wrong-numbered elements and/or such elements per se. More specifically, a display as shown in FIG. 22 is rendered, for example. However, in order to show messages to a user, any other styles and wording are feasible.

Accordingly, the third embodiment of the present invention enables the analysis of a specification, whereby the consistency of reference numerals can be checked. Using this feature, one can draft a specification in a more efficient manner.

It should be noted that in the third embodiment, the kind of algorithm used for checking the numerical consistency is not limited to the above.

Moreover, the third embodiment sets forth that if multiple different numbers are assigned to one element within a certain range of a specification, the judgment part judges that such an element is wrong-numbered. However, a “certain range of a specification” is not limited to one embodiment, and may also be the whole part of the preferred embodiments.

As set forth in the third embodiment, in order to display wrong-numbered elements, the presence of such elements and/or such elements per se are displayed. However, the presence of such elements may also be made known to a user, for example, by showing a message.

The operations described in the third embodiment of the present invention may be realized using a computer-readable program. Such a program may be distributed in a recording medium such as a CD-ROM or through network, or may be broadcast. A program for executing the operations of the data processing device as set forth in the third embodiment is provided for enabling a computer to execute: a numbered element obtainment step of analyzing a specification, and obtaining elements with reference numerals therefrom; a judgment step of judging which element or elements are wrong-numbered from more than one element obtained in the numbered element obtainment step; and an incorrect portion output step of outputting the presence of any wrong-numbered elements and/or such elements per se.

### Industrial Applicability

A data processing device of the present invention is effective for use as a device capable of assessing the quality or value of a patent specification in an objective manner.

1. A program for enabling a computer to execute:
a specification analysis step of reading-in a specification and analyzing said specification;
a patent value calculation step of quantitatively calculating a patent value based on analysis results obtained in said specification analysis step; and
a patent value output step of outputting said patent value.

2. The program as set forth in claim 1, wherein
said patent value calculation step calculates a value for each of a plurality of characteristics intrinsic to said specification, and
said patent value output step outputs said value for each of said plurality of characteristics.

3. The program as set forth in claim 2, wherein
said characteristics include at least a specification disclosure level, and
said patent value calculation step calculates at least said specification disclosure level using an amount of description for claims and an amount of a portion or entirety of description for preferred embodiments as parameters.

4. The program as set forth in claim 2, wherein
said characteristics include at least an inventive feature extraction level, and
said patent value calculation step calculates at least said inventive feature level using the smallest number of elements composing one claim as a parameter.

5. The program as set forth in claim 2, wherein
said characteristics include at least an invention expansion level, and
said patent value calculation step calculates at least said invention expansion level using at least one of a number of claims, a depth of claim nesting level, and a number of claim categories as parameters.

6. A data processing device comprising:
a specification read-in part for reading-in a specification;
a specification analysis part for analyzing said specification;
a patent value calculation part for quantitatively calculating a patent value based on analysis results obtained by said specification analysis part; and
a patent value output part for outputting said patent value.

7. The data processing device as set forth in claim 6, wherein
said patent value calculation part calculates a value for each of a plurality of characteristics intrinsic to said specification, and
said patent value output part outputs said value for each of said plurality of characteristics.

8. The data processing device as set forth in claim 7, wherein
said characteristics include at least a specification disclosure level, and
said patent value calculation part calculates at least said specification disclosure level using an amount of description for claims and an amount of a portion or entirety of description for preferred embodiments as parameters.

9. The data processing device as set forth in claim 7, wherein
said characteristics include at least an inventive feature extraction level, and
said patent value calculation part calculates at least said inventive feature extraction level using a smallest number of elements composing one claim as a parameter.

10. The data processing device as set forth in claim 7, wherein
said characteristics include at least an invention expansion level, and
said patent value calculation part calculates at least said invention expansion level using at least one of a number of claims, a depth of claim nesting level, and a number of claim categories as parameters.
